(19) United States
(12) Patent Application Publication
(10) Pub. No.: US 2006/0176444 A1
(43) Pub. Date: Aug. 10, 2006

(54) Frameless eyeglass assembly with auxiliary lens attachment

(76) Inventor: Ira Lerner, New York, NY (US)

Correspondence Address: Thomas A. O'Rourke;Bodner & O'Rourke, LLP, 425 Broadhollow Road, Melville, NY, 11747, US

(21) Appl. No.: 10/942,739

(22) Filed: Sep. 16, 2004

Related U.S. Application Data
(60) Provisional application No. 60/503,189, filed on Sep. 16, 2003.

(51) Int. Cl. G02C 1/02

(52) U.S. Cl. 351/110

(57) ABSTRACT

Frameless eyeglasses and an auxiliary lens assembly are adapted to be magnetically attached to each other. The auxiliary lens assembly has a first auxiliary lens attached to a second auxiliary lens by a bridge member. The auxiliary lens assembly has at least one a magnetic member thereon. The magnetic member is adapted to magnetically attach to a second magnetic member on the frameless eyeglasses. At least one of the magnetic members is a magnet and the other is made from a material that is attracted to a magnet.

### BACKGROUND OF THE INVENTION

Many people have the need for eyeglasses that correct their vision. Although contact lenses have long been an alternative to wearing eyeglasses, many people choose not to wear them for various reasons, including cost, inconvenience, discomfort and allergic reactions. More recently, laser eye surgery has also become an alternative to wearing eyeglasses, but here too, many people want neither the cost nor surgical procedures involved with this alternative. Thus, many prescription eyeglass wearers prefer to wear their glasses even though these other alternatives exist. In fact, many people consider eyewear very stylish and aesthetically pleasing to wear on their face. To this end, many improvements have been made to the size, shape and comfort of the frames, lenses, nose pads, etc.

Many who prefer to wear prescription eyeglasses also have a need for sunglasses to protect their eyes from the harmful UV rays of the sun. Even if the sunglasses should be made with the wearer's corrective eyeglass prescription, they are usually too dark in tint to be useful indoors, accordingly, persons who need both prescription eyeglasses and sunglasses often have to carry two pairs of eyeglasses with them. This can be both cumbersome and expensive. One solution for having two pairs of eyeglasses (a prescription pair of eyeglasses and a pair of sunglasses) is the invention of the “clip-on” lens attachment, wherein a pair of auxiliary lenses are mounted in a wire or plastic frame that attach mechanically to the wearer's primary pair of prescription eyewear by means of several “hooks” or “clips”. Auxiliary lenses are typically UV-protective lenses (sunglasses) or additional prescription lenses which can be attached to a pair of primary lenses. Much of the prior art for auxiliary lens attachments provide snap fits or other mechanical means for attaching the auxiliary lens to the primary lens.

For those who want to continue to wear eyeglasses, a significant improvement has involved the methods of attachment of auxiliary lenses. The “clip-on” method worked well for primary lenses housed in large frames. However, in recent years, many eyeglass wearers have preferred to wear eyeglasses with smaller frames or no frames at all. As the size of many eyeglass frames became smaller, the clips necessary to attach the auxiliary lenses became more unsightly and objectionable to many eyeglass wearers.

As a result, there have been a number of manufacturers of auxiliary lens systems who have abandoned the use of the traditional “clips”, “hooks” or clipping means and have relied on the use of magnetic means to secure an auxiliary lens to the primary lens. These magnetic means are disclosed in a number of patents including U.S. Pat. Nos 5,642,177 (Nishioka), U.S. Pat. No. 6,132,040 (Xiao), Re. 37,545 (Chao), the disclosures of which are incorporated herein by reference. These magnetic means incorporate a magnet in either the frame of the primary lenses or in the frame of the auxiliary lens. A magnet or a material that is attracted to the magnet is used in the other. As a result, a user can readily remove or attach an auxiliary lens to the primary lens. When the clip means are used it is frequently a complex manipulation to secure the auxiliary frame to the primary frame, often requiring the wearer to remove the primary pair of eyeglasses and use both hands to ensure that the hooks do not scratch the expensive prescription lenses. As a result, there can be difficulties when, for example, a driver needs to remove an auxiliary frame from the primary frame when going from bright sunlight into a darkened tunnel. The frames having the magnetic means of attachment facilitate the application and removal of the auxiliary lenses to the primary lens, and usually require the use of only one hand.

While the auxiliary lenses having a magnetic securing means have achieved a great deal of popularity, they do have one drawback. Recently, eyeglasses known as frameless eyeglasses have become popular amongst the public. These glasses do not have the necessary frame for receiving a magnet or a magnet attracting material. Accordingly, there is a need to provide a magnetic means for securing an auxiliary lens to a pair of frameless eyeglasses. Additionally, there is a need to provide magnetic means for securing frameless auxiliary lenses to primary frameless eyeglasses that allow the auxiliary lenses to match the shape and size of the lenses of the primary eyeglasses.

### OBJECTS OF THE INVENTION

It is an object of the present invention to provide an assembly for attaching auxiliary lenses to frameless eyeglasses in which a pair of secondary lenses can match any size and/or shape of the primary lenses of the primary frameless eyeglasses.

It is an object of the present invention to provide an assembly for attaching auxiliary lenses to frameless eyeglasses that reduces the cost of making expensive frames to hold the auxiliary lenses.

It is an object of the present invention to provide an assembly for attaching auxiliary lenses to frameless eyeglasses which is easy to assemble.

It is an object of the present invention to provide an assembly for attaching auxiliary lenses to frameless eyeglasses which is easily attached and removed from the primary frameless eyeglasses.

It is an object of the present invention to provide an assembly for attaching auxiliary lenses to frameless eyeglasses that can attach at or near the outer portion of the lens or near the bridge of the nose.

### SUMMARY OF THE INVENTION

A primary pair of eyeglasses typically comprises a pair of temple bar members that are each hingedly attached to a frame member. The frame member is usually a metal or plastic housing which holds a pair of lenses. However, because many eyeglass wearers do not like the additional weight, discomfort and unpleasing appearance of the frame members, manufacturers have replaced the frame members with a pair of lens connectors that attach to each temple bar member. Each lens connector is fixed to a portion of a lens, and the lenses are attached by a bridge member. The primary pair of eyeglasses usually has transparent, prescription lenses. In some eyeglasses, however, the lenses are light-sensitive and change tint due to the amount of ultra-violet (UV) light incident upon them. Additionally, lenses which limit the amount of UV light besetting the cornea have been manufactured and are commonly referred to as sunglasses.

Most eyeglass wearers who want to wear both their transparent lens eyeglasses and sunglasses must purchase two separate pairs, each with the same prescription, but different tints. However, eyeglass manufacturers have developed auxiliary attachments which can removably adhere to the primary eyeglasses. The auxiliary attachments can have tinted lenses or lenses with a different prescription(s), thereby eliminating the need for pairs of eyeglasses and sunglasses, each with the same prescription, which can be very costly. Formerly, the auxiliary attachments would mechanically clip to, or magnetically attach to, the bulky frame of the primary eyeglasses. However, the advent of frameless eyeglasses has made this attachment more difficult, while still desired.

The present invention teaches an auxiliary attachment for primary eyeglasses. More specifically, the auxiliary attachment of the present invention is made for primary eyeglasses, which are frameless and have limited attachment points. Frameless eyeglasses typically comprise a pair of temple bar members that hingedly attach to lens connectors. The lens connectors attach to the lenses of the eyeglasses, and the lenses are attached by a bridge member. Commonly, the lens connectors and bridge member are made of a relatively thin wire or plastic, thus limiting the attachment and adhesion points for auxiliary frames.

The present invention is directed to an assembly for attaching auxiliary lenses to frameless eyeglasses employing the use of at least one pair of magnetic members. For the purposes of describing this invention and all embodiments contained herein, the term “magnetic member” shall mean a magnet or a material that is attracted to a magnet. Therefore, each pair of attracting magnetic members always includes at least one magnetic member that is a magnet. The other magnetic member may be a magnet or a material that is attracted to a magnet. More specifically, the assembly of the present invention incorporates one or more magnets to facilitate the attachment of the auxiliary lenses to one or more points on a set of frameless eyeglasses. One magnetic member of a pair may be on the inner surface of one or both lenses of the auxiliary glasses where it contacts the corresponding magnetic member of the pair on the outer surface of one or both of the lenses of the primary glasses. In a second embodiment, one magnetic member may be on the inner surface of the bridge of the auxiliary glasses and the other magnetic member may be on the outer surface of the bridge of the primary glasses.

The present invention includes a pair of auxiliary lenses. The auxiliary lenses may be in any form including but not limited to lenses that may be tinted without prescription, tinted with prescription, untinted with prescription, or changeable as to tint according to the amount of UV light present. The auxiliary lenses can be connected by a second bridge member. It should be noted that the auxiliary lenses need not be the same size, shape, orientation or prescription as the primary lenses, although it is usually preferred that they are the same size and shape.

On the second bridge member of the auxiliary attachment, a magnetic member may be positioned along or in at least a portion of an inner surface. The magnetic member on the inner surface of the second bridge member can contact the bridge member on the primary eyeglasses. In this embodiment, at least a portion of the bridge member on the primary eyeglasses has magnetic characteristics that allow the auxiliary attachment to removably adhere to the primary eyeglasses. The magnetic characteristic may be in or on at least a portion of the bridge member of the primary eyeglasses. For further support or as alternative support of the auxiliary attachment, a magnetic member may be attached to or embedded in each lens of the auxiliary attachment. The magnetic members on the auxiliary attachment are then secured to the corresponding magnetic members on the primary eyeglasses by magnetic means wherein at least one of each pair of corresponding magnetic members is a magnet and the other magnetic member is a magnet or a magnetically attracted material.

The magnetic members are preferably a size that will provide enough surface area for magnetic attachment, but will not obstruct the wearer's field of vision. The magnetic members on the primary frameless eyeglasses and on the auxiliary attachment may be screws, the face or base of screws, the lens connector, or other means used to secure the lens to the lens connectors, or may be secured to or removably adhered to the face or base of a screw or other member used to secure the lens to the lens connector of the primary eyeglasses. Thus, the wearer can, walk, run or drive and freely move about without worrying that the attachment will dislodge or fall off the primary eyeglasses.

In another embodiment, the magnets may be on the auxiliary eyeglasses and a magnetic material attracted to the magnet may be on the primary eyeglasses. On the bridge member of the primary eyeglasses, a magnet may be positioned along or in at least a portion of an outer surface. The magnet on the outer surface of the primary bridge member can contact a material attracted to a magnet on the inner surface of the bridge member on the auxiliary lenses. In this embodiment, at least a portion of the inner surface of the bridge member on the auxiliary eyeglasses has magnetic characteristics which allow the auxiliary attachment to removably adhere to the primary eyeglasses. The magnetic characteristic may be in or on at least a portion of the bridge member of the primary eyeglasses.

For further support or as alternative support of the auxiliary attachment, a magnet may be attached to the inner surface of each lens of the auxiliary lenses. As noted above, the embedded magnets are preferably a size which will provide enough surface area for magnetic attachment, but will not obstruct the wearer's field of vision. The embedded magnets be the screws or other means used to secure the lenses to the lens connectors or may secured to or removably adhered to the face or base of a screw or other member used to secure the lens to the lens connector of the primary eyeglasses.

The attachment of the magnetic member, whether by embedding in the lens or lens connector, housing in a sleeve, attachment using screws, adhesives or welding can be varied. Additionally, the bridge member itself and/or the lens connector may be a magnetic member. Also, the number, size and shape of the magnets may vary due to comfort, fashion, appearance or activity. The magnets may be any suitable magnetic material including but not limited to rare earth magnets such as neodymium magnets.

### BRIEF DESCRIPTION OF THE DRAWINGS

FIG. 1 is an exploded view of primary eyeglasses and the auxiliary attachment of the present invention.

FIG. 2 is a top view of the auxiliary attachment of the present invention connected to primary eyeglasses.

FIG. 3 is a cross-sectional view of the connection of the auxiliary attachment of the present invention to a lens connector of primary eyeglasses.

FIG. 4 is a sectional view of the connection of the auxiliary attachment of the present invention to a lens connector of primary eyeglasses.

FIG. 5 is a sectional view of a separate embodiment of the connection of the auxiliary attachment of the present invention to a lens connector of primary eyeglasses.

FIG. 6 is a sectional view of the connection of the auxiliary attachment of the present invention to a bridge member of primary eyeglasses.

FIG. 7 is a sectional perspective view of a separate embodiment of the auxiliary attachment of the present invention as connected to a lens connector of primary eyeglasses.

FIG. 8 shows an alternate embodiment to that of FIG. 1, in which the lens of the auxiliary eyeglasses do not have lens connectors.

FIG. 9 shows an alternate embodiment to that of FIG. 7, in which the lens of the auxiliary eyeglasses have lens connectors.

FIG. 10 shows an alternate method of Figure number 9 in which the magnetic member on the auxiliary lens connector is adhesively secured instead of embedded.

FIG. 11 is a detail of the sleeve that holds the magnetic member where a retaining lip has been added.

### DETAILED DESCRIPTION OF THE INVENTION

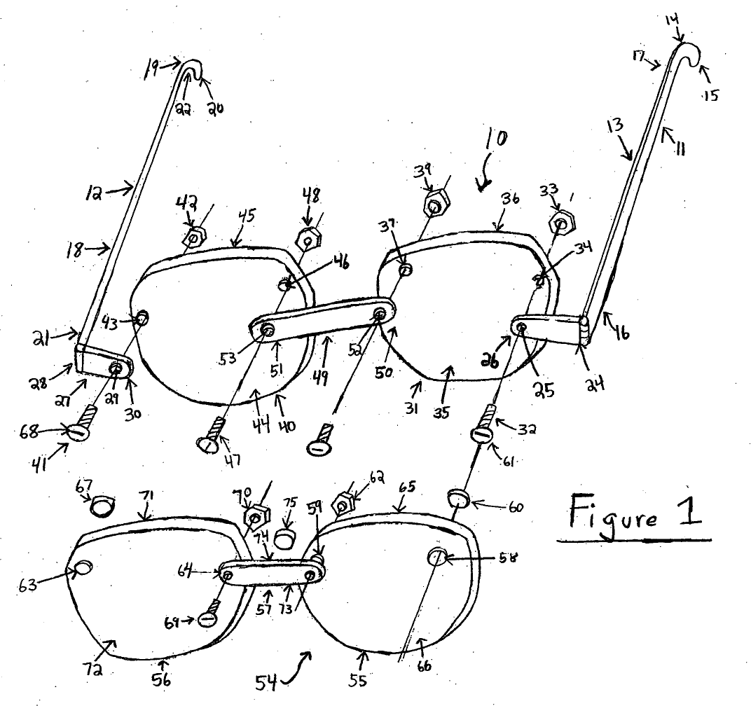

As seen in FIG. 1, a pair of primary eyeglasses 10 may for example include but is not required to have a first temple bar member 11 and a second temple bar member 12. First temple bar member 11 can have a length member 13, a transition point 14 and an ear-retaining member 15. The length member 13 has a first end 16 and a second end 17. Second end 17 can be attached to the transition point 14, which may be rounded or angled. Transition point 14 can connect length member 13 to ear-retaining member 15. In is understood that some embodiments of primary eyeglasses may not have a transition point or ear-retaining member. In these embodiments, the length member may or may not have means to retain the primary eyeglasses behind the wearer's ear or head.

Second temple bar member 12 is generally but need not be a mirror image of first temple bar member 11. Second temple bar member can have a length member 18, a transition point 19 and an ear-retaining member 20. The length member 18 has a first end 21 and a second end 22. Second end 22 can be attached to the transition point 19, which may be rounded or angled. Transition point 19 can connect length member 18 to ear-retaining member 20.

First temple bar member 11 preferably hingedly attaches to a first lens connector 23. The hinged attachment should allow first temple bar member 11 to have generally at least a 90 degree range of motion. First lens connector 23 is preferably flat, but can be rounded or angled, with a hinged connection at a first end 24 and a hole 25 at a second end 26. Second temple bar member 12 preferably hingedly attaches to a second lens connector 27. The hinged attachment should allow second temple bar member 12 to have at least a 90 degree range of motion. Second lens connector 27 is preferably flat, but can be rounded or angled, with a hinged connection at a first end 28 and a hole 29 at a second end 30.

First lens connector 23 is preferably attached to a first lens 31 by a screw 32 and nut 33 combination. First lens 31 can have a first hole 34, which can receive screw 32. Screw 32 can pass through hole 25 on first lens connector 23, through first hole 34 on first lens 31 and fasten to first lens 31 by means of a nut 33. First lens 31 can have an outer surface 35 and an inner surface 36. Nut 33 can be positioned on inner surface 36. First lens 31 can also have a second hole 37. Second hole 37 can receive a screw 38, which can attach to a nut 39 on inner surface 36 of first lens 31.

Second lens connector 27 is preferably attached to a second lens 40 by a screw 41 and nut 42 combination. Second lens 40 can have a first hole 43, which can receive screw 41. Screw 41 can pass through hole 29 on second lens connector 27, through first hole 43 on second lens 40 and fasten to second lens 40 by means of a nut 42. Second lens 40 can have an outer surface 44 and an inner surface 45. Nut 42 can be positioned on inner surface 45. Second lens 40 can also have a second hole 46. Second hole 46 can receive a screw 47, which can attach to a nut 48 on inner surface 45 of second lens 40.

Attaching first lens 31 to second lens 40 can be a bridge member 49. Bridge member 49 preferably has a first end 50 and a second end 51. First end 50 can have a first hole 52; second end 51 can have a second hole 53. First hole 52 can receive screw 38, which can pass through second hole 37 of first lens 31. Second hole 53 can receive screw 47, which can pass through second hole 46 of second lens 40.

It is understood that the assembly of primary eyeglasses 10 can have varying methods of attachments in addition or replacement of screws and nuts. For example, adhesives may be used to limit wear on the finish of the lens. Also, snap fit pieces may be used to reduce the number of mechanical parts. Additionally, it is contemplated that the temple bar members, lens connectors, and bridge member may be manufactured from any suitable material, including but not limited to: plastic, acetate, rubber, polymers, synthetic materials, metal, metal alloys, natural materials and wire. The parts and lenses of the primary eyeglasses may be any shape, orientation, color or size.

The auxiliary attachment of the present invention is seen generally at 54. A first auxiliary lens 55 can be attached to a second auxiliary lens 56 by a bridge member 57. It is appreciated that the auxiliary lens can be any size, shape, orientation, tint or prescription. In a preferred embodiment the auxiliary lens will fit directly over, but not contacting, the primary lens. The limitation on the contact between the auxiliary lenses and the primary lenses will prevent scratching should the lenses contact each other.

First auxiliary lens 55 can have a first hole 58 and a second hole 59. First hole 58 can house a magnet 60. In a preferred embodiment, magnet 60 is the same size as the face 61 of screw 32. Also, in this embodiment, screw 32, or at least face 61 of screw 32, will have magnetic characteristics that will allow magnet 60 to magnetically attach to screw 32. Second hole 59 can receive a screw (not shown), which can fasten bridge member 57 to first auxiliary lens 55 by way of a nut 62. First auxiliary lens 55 can have an inner surface 65 and an outer surface 66.

Second auxiliary lens 56 can have a first hole 63 and a second hole 64. First hole 63 can house a magnet 67. In a preferred embodiment, magnet 67 is the same size as the face 68 of screw 41. Also, in this embodiment, screw 41, or at least face 68 of screw 41, will have magnetic characteristics that will allow magnet 67 to magnetically attach to screw 41. Second hole 64 can receive a screw 69, which can fasten bridge member 57 to second auxiliary lens 56 by way of a nut 70. Second auxiliary lens 56 can have an inner surface 71 and an outer surface 72.

In other embodiments of the present invention magnet 60 and 67 do not need to align with the face 61 of screw 32 and face 68 of screw 41 respectively, but can instead align with a portion of the lens connector that has magnetic characteristics. In this embodiment the lens connector itself may be a magnet or be made of a magnet attracting material.

Bridge member 57 can have an outer surface 73 and an inner surface 74. Positioned on inner surface 74 can be a magnet 75. Magnet 75 can be any size or shape. Bridge magnet 75 can removably, magnetically attach to bridge member 49 on primary eyeglasses 10. Bridge member 49 on primary eyeglasses 10 should have suitable magnetic characteristics such that bridge magnet 75 can magnetically adhere to it.

When auxiliary attachment 54 is used, embedded magnets 60 and 67 will magnetically adhere to screws 32 and 41, respectively. Additionally, bridge magnet 75 will magnetically adhere to bridge member 49. It is understood that only the embedded magnets may be used, or only the bridge magnet may be used, or any other combination of the magnets. The auxiliary attachment of the present invention confers the advantages of ease of attachment and removal from primary eyeglasses, they are lightweight, compact (as there are no protruding “magnetic arms”), have aesthetic design flexibility, as well as strong adhesive characteristics, due to the strength and position of the magnets.

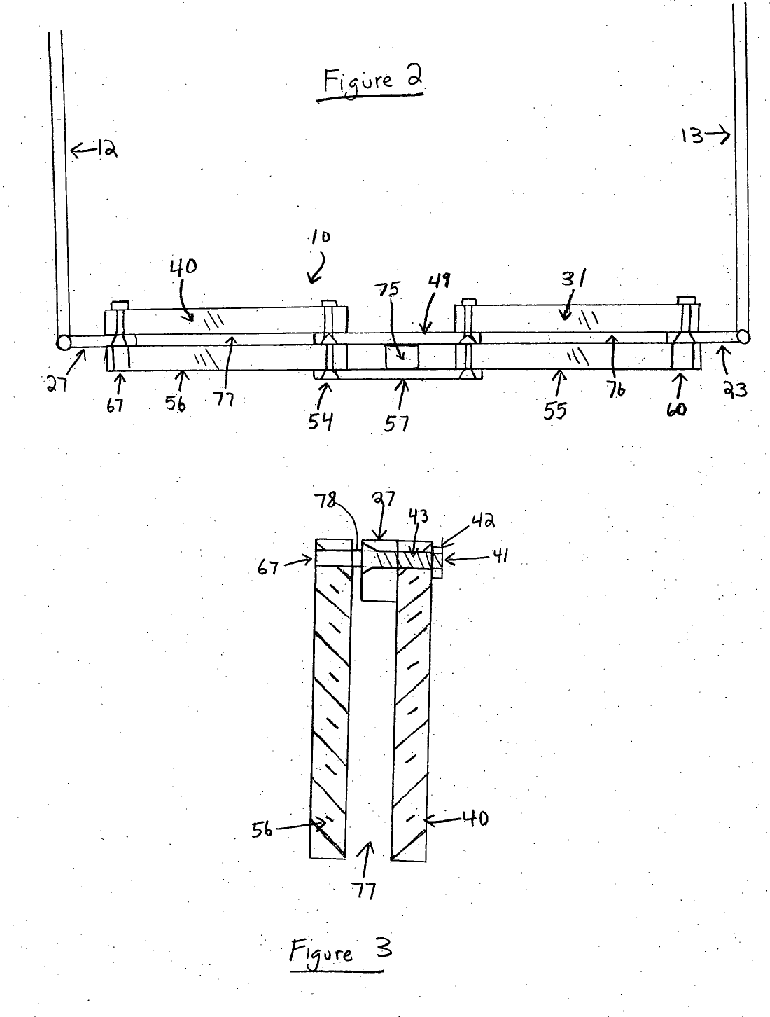

As seen in FIG. 2, the lenses of the auxiliary attachment 54 do not contact the lenses of the primary eyeglasses 10. Between first lens 31 and first auxiliary lens 55 is air gap 76. Between second lens 40 and second auxiliary lens 56 is air gap 77. The air gaps created by the auxiliary attachment prevent contact between the lenses, which can form scratches. Also, FIG. 2 shows the nature of the flush fit of the auxiliary attachment due to the embedded magnets. Preferably, the bridge magnet 75 will be as thick as the auxiliary lenses to further enhance the flush fit, thereby providing the auxiliary attachment with a lightweight feel. Lightweight auxiliary attachments are desirable, because the wearer can feel like he or she is wearing one pair of glasses without purchasing single pairs, simply for different prescriptions, tints or styles.

FIG. 3 shows an alternative embodiment of the connection between second auxiliary lens 56 and second lens 40. Magnet 67 has been embedded in second auxiliary lens 56 and has an extension portion 78 that extends past inner surface 71 into air gap 77. In this embodiment, the lengthening of magnet 67 through extension portion 78 into air gap 77 further limits the possible scratching of lenses which could result from the lens contacting screw 41. The arrangement of the first auxiliary lens and the first lens can be the same or different if desired.

FIG. 4 shows a further embodiment of the connection between for example, the second auxiliary lens 56 and second lens 40. In this embodiment, magnet 67 is no longer embedded in auxiliary lens 56. Magnet 67 can be bonded to inner surface 71 of second auxiliary lens 56. Adhesive 79 can be positioned on inner surface 71 and bond second auxiliary lens 56 to magnet 67. Adhesive 79 can be any suitable bonding medium, including but not limited to glue, epoxy or gel. Preferably, adhesive 79 can suitably bond glass to metal. The first auxiliary lens and the first lens can be secured in a similar manner if desired.

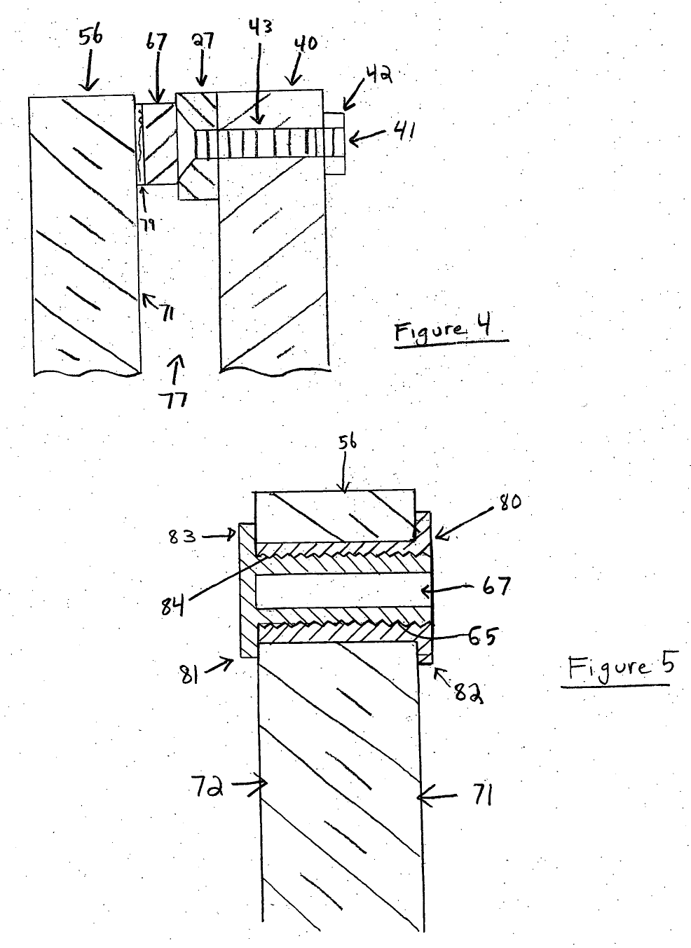

As seen in FIG. 5, magnet 67 may be embedded in a different manner in second auxiliary lens 56 than previously described. In this embodiment, magnet 67 can be housed in an exterior sleeve 81. Exterior sleeve 81 preferably passes through second auxiliary lens 56. Exterior sleeve 81 can have a flange 83, which contacts outer surface 72 of second auxiliary lens 56 and can maintain exterior sleeve's position and orientation within second auxiliary lens 56. The portion of exterior sleeve 81 which passes through second auxiliary lens 56 can have teeth or threads 84 so that the two parts of the sleeve thread or are joined together. Teeth 84 can provide a secure fit with interior sleeve 80. Interior sleeve 80 can have teeth 85, which are complimentary to teeth 84 of exterior sleeve 81. Teeth 85 of interior sleeve 80 allow it to fit over exterior sleeve 81. Thus, interior sleeve 80 can provide a secure fit for the sleeves in the second auxiliary lens 56, while the exterior sleeve 81 can house magnet 67. Magnet 67 may fit securely into exterior sleeve 81 with or without the use of adhesive. Magnet 67 may also be secured in the sleeve by the addition of a retaining lip on the open end or ends of the sleeve housing. See FIG. 11. The teeth 85 can be replaced with mating threads. Accordingly, the interior sleeve can be threaded into the exterior sleeve.

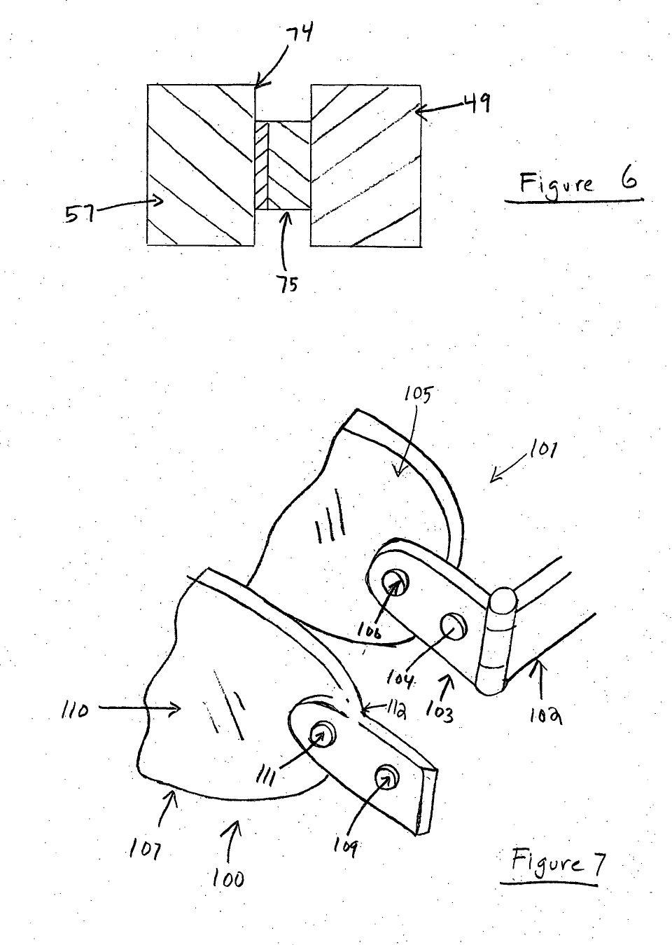

FIG. 6 is a depiction of the bridge magnet connection of the present invention. Bridge member 57 of auxiliary attachment 54 can have a bridge magnet 75 attached to it by adhesive, welding, embedding in the bridge member or other suitable means. In a preferred embodiment, an adhesive 86 is applied to inner surface 74 of bridge member 57 of auxiliary attachment 54. The adhesive 86 can attach bridge magnet 75 to bridge member 57. The bridge magnet 75 can magnetically attach to bridge member 49 of primary eyeglasses 10. In this embodiment, bridge member 49 should have magnetic characteristics that will allow bridge magnet 75 to magnetically attach to it.

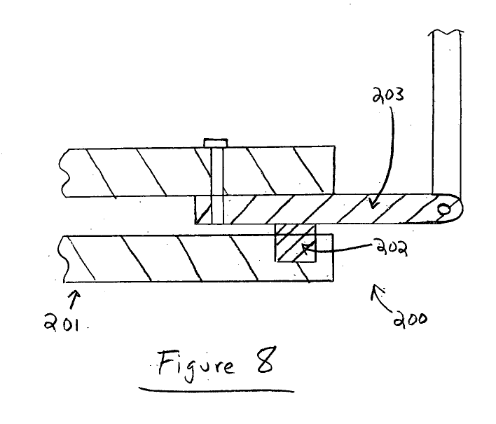

FIG. 7 depicts an alternative embodiment of the present invention shown generally at 100. In this embodiment, primary eyeglasses 101 comprise a temple bar member 102 hingedly attached to a lens connector 103. Embedded in lens connector 103 is a magnet 104. Lens connector 103 is fixed to primary lens 105 by a screw 106 and nut (not shown). The alternate embodiment of the auxiliary attachment is shown at 107. Auxiliary attachment 107 can include a lens connector 108. Lens connector 108 can be similarly constructed to lens connector 103 of primary eyeglasses 101. A magnet 109 can be embedded in lens connector 108. In a preferred embodiment, lens connectors 103 and 108 and magnets 104 and 109 will align and rest against one another when the auxiliary attachment is worn. Lens connector 108 can be fixed to auxiliary lens 110 by a screw 111 and a nut (not shown). However, in this embodiment, the lens connector 108 may be fixed to an inner surface 112 of auxiliary lens 110. Fixing to the inner surface 112 of auxiliary lens 110 will allow the magnets of the lens connectors to magnetically attach to each other. In another embodiment, the lens connector can be fixed to the outer surface of auxiliary lens 110 instead, and have the lens connector made with a “cut-out” so it screws to the outer surface and the part that holds the magnet will widen at the edge of the lens so the inner side of the lens connector is flush with the inner side of the auxiliary lens as well. This embodiment prevents the lenses from being too far away from one another and limits the amount of sunlight that may enter from above and cause internal reflections between the lenses.

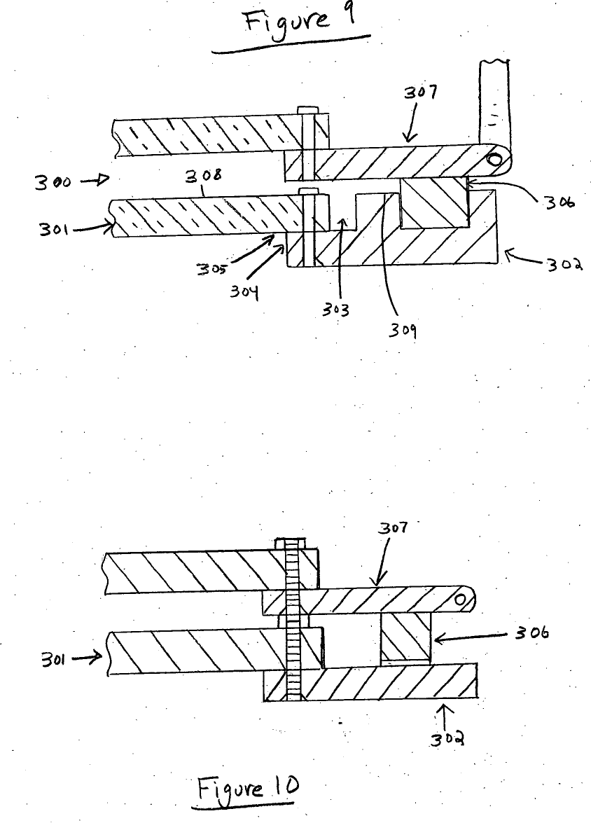

FIG. 8 shows an alternate embodiment to that of FIG. 1, which is generally shown at 200. In this embodiment, each auxiliary lens 201 of the auxiliary eyeglasses do not have lens connectors. FIG. 8 illustrates an embodiment in which a magnetic member 202 is embedded in the auxiliary lens 201. The auxiliary lens can attach by magnetic means to a portion of the primary lens connector 203 that does not have a screw. The primary lens connector 203 is a magnetic member, being either a magnet or a magnet attracting material.

FIG. 9 shows an alternate embodiment to that of FIG. 7 shown generally at 300. In this embodiment, the auxiliary lens 301 of the auxiliary eyeglasses has an auxiliary lens connector 302. In a preferred embodiment as shown in FIG. 9, the auxiliary lens connector 302 has a cut-out 303 between it and the auxiliary lens 301. Preferably, an interior side 304 of the auxiliary lens connector 302 is flush with the exterior side 305 of the auxiliary lens 301. Alternatively or along with the preferred embodiment, interior side 308 of auxiliary lens 301 can be generally in the same plane as an interior surface 309 of the auxiliary lens connector 302. An auxiliary magnetic member 306 is embedded in the auxiliary lens connector 302 so that it magnetically adheres to a primary lens connector 307, a portion of which or all of which is a magnetic member. The purpose of this method is to keep the primary and auxiliary lenses from scratching with the minimum amount of space between the two lenses. In the instance more space is required between the two lenses, the embodiment in FIG. 7 would be preferred.

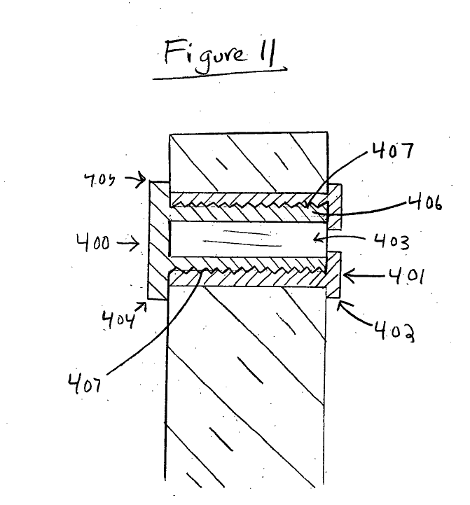

FIG. 10 shows an alternate embodiment of FIG. 9 in which the auxiliary magnetic member 306 on the auxiliary lens connector 302 is adhesively secured instead of embedded.

FIG. 11 is a detail of an alternative embodiment 400 for the sleeve that holds the magnetic member. A retaining lip 401 has been added to exterior sleeve 402. A magnetic member 403 can be inserted into interior sleeve 404 when the sleeves are apart, but after they are attached, by threading for example, the magnetic member 403 cannot be removed. Flanges 405, which extend outward from both the male 406 and female 407 parts of the exterior and interior sleeves, respectively, are able to keep the sleeves mechanically secured to the auxiliary lens without the use of adhesives or other means if so desired.

The present invention contemplates further embodiments in which the primary lenses and/or auxiliary lenses are tinted or non-tinted, prescription or non-prescription, protective or vision enhancing lenses for a computer monitor, lab or work environment.

I claim:

1. In combination, frameless eyeglasses and an auxiliary lens assembly adapted to be magnetically attached thereto comprising an auxiliary lens assembly having a first auxiliary lens attached to a second auxiliary lens by a bridge member, said auxiliary lens assembly having at least one a magnetic member thereon said magnetic member being adapted to magnetically attach to a second magnetic member on said frameless eyeglasses, and wherein at least one of said magnetic members is comprised of a magnet and the other is comprised of a magnet or a material that is attracted to a magnet.

2. The combination according to claim 1 wherein at least one of said first and second auxiliary lenses have at least one orifice having a magnetic member therein said magnetic member being adapted to magnetically attach to a screw on said frameless eyeglasses, said screw being comprised of a second magnetic member and wherein at least one of said magnetic members is comprised of a magnet and the other is comprised of a magnet or a material that is attracted to a magnet.

3. The combination according to claim 2 wherein said screw is a magnet.

4. The combination according to claim 2 wherein said screw is comprised of a material that is attracted to a magnet.

5. The combination according to claim 4 wherein said magnet is about the same size as a face of said screw on said frameless eyeglasses.

6. The combination according to claim 1 wherein said bridge member of said auxiliary lens assembly has a first surface and a second surface, said second surface being adapted to being adjacent to an outer surface of a bridge on said frameless eyeglasses comprising a magnetic member, said auxiliary lens assembly bridge having on said second surface a magnetic member for magnetically attaching said bridge magnetic member to the bridge member of said frameless eyeglasses and wherein at least one of said magnetic members is comprised of a magnet and the other is comprised of a magnet or a material that is attracted to a magnet.

7. The combination according to claim 6 wherein said auxiliary lens assembly bridge has a magnet thereon.

8. The combination according to claim 6 wherein bridge member of said frameless eyeglasses has a magnet thereon.

9. The combination according to claim 2 wherein the lenses of the auxiliary lens assembly do not contact the lenses of said frameless eyeglasses.

10. The combination according to claim 2 wherein the lenses of the auxiliary lens assembly and the lenses of said frameless eyeglasses have an air gap between them.

11. The combination according to claim 5 wherein the magnet on said bridge has a thickness about the same thickness as the auxiliary lenses to provide a flush fit between the frameless eyeglasses and said auxiliary lens assembly.

12. The combination according to claim 1 wherein at least one of said first and second auxiliary lenses has a magnetic member embedded in said auxiliary lens, said magnetic member having a magnetic extension portion that extends past an inner surface of said lens into an air gap.

13. The combination according to claim 1 wherein at least one of said first and second auxiliary lenses has a magnetic member bonded to an inner surface of said auxiliary lens.

14. The combination according to claim 13 wherein an adhesive is present on said inner surface and bonds said auxiliary lens to said magnetic member.

15. The combination according to claim 14 wherein said adhesive can bond plastic lens materials to metal.

16. The combination according to claim 1 wherein at least one lens of said auxiliary lens has a magnetic member housed in a sleeve, said sleeve passing through said auxiliary lens.

17. The combination according to claim 16 wherein said sleeve has a flange which contacts an outer surface of said auxiliary lens and can maintain said sleeve's position and orientation within said auxiliary lens.

18. The combination according to claim 17 wherein a portion of said sleeve which passes through said auxiliary lens has one or more teeth so that said teeth provide a secure fit with a second sleeve.

19. The combination according to claim 18 wherein said second sleeve has teeth on an exterior surface of said sleeve which are complimentary to said teeth on an interior surface of said first sleeve.

20. The combination according to claim 19 wherein the teeth of said second sleeve allow said sleeve to fit over said first sleeve so that said second sleeve can provide a secure fit for the sleeve in the auxiliary lens, while the first sleeve can house said magnetic member.

21. The combination according to claim 20 wherein said magnetic member is secured in the first sleeve by the addition of a retaining lip on at least one open end of said sleeve.

22. The combination according to claim 17 wherein a portion of said first sleeve which passes through said auxiliary lens has one or more threads so that said thread provides a secure fit with a second sleeve.

23. The combination according to claim 22 wherein said second sleeve has at least one thread on an exterior surface of said sleeve which are complimentary to said thread on said first sleeve.

24. The combination according to claim 6 wherein the bridge member of said auxiliary lens assembly has a magnetic member attached thereto by embedding said magnetic member in said bridge member so that said magnetic member can magnetically attach said assembly to a bridge member of said pair of frameless glasses.

25. The combination according to claim 1 wherein said frameless eyeglasses comprise a temple bar member hingedly attached to a lens connector, and embedded in said lens connector is a magnetic member said magnetic member being adapted to magnetically attach said lens connector to a connector comprised of a magnetic member on said auxiliary lens assembly and wherein at least one of said magnetic members is comprised of a magnet and the other is comprised of a magnet or a material that is attracted to a magnet.

26. The combination according to claim 25 wherein said magnetic member on said auxiliary lens assembly is a magnet.

27. The combination according to claim 25 wherein said magnetic member on said lens connector is a magnet.

28. The combination according to claim 1 wherein said auxiliary lens assembly comprises a lens connector, and embedded in said lens connector is a magnetic member and wherein said magnetic member being adapted to magnetically attach to a lens connector comprised of a magnetic member on a pair of frameless eyeglasses and wherein at least one of said magnetic members is comprised of a magnet and the other is comprised of a magnet or a material that is attracted to a magnet.

29. The combination according to claim 1 wherein said auxiliary lens has a first side and a second side, one of said sides being adapted to be adjacent to said frameless eyeglasses when said auxiliary lens assembly is attached to said frameless eyeglasses, at least one of said auxiliary lens having a magnetic member embedded in the side of said auxiliary lens adjacent said frameless eyeglasses, said auxiliary lens being adapted to attach said auxiliary lens assembly to said a magnetic member on said frameless eyeglasses and wherein at least one of said magnetic members is comprised of a magnet and the other is comprised of a magnet or a material that is attracted to a magnet.

30. The combination according to claim 29 wherein said magnetic member embedded in said auxiliary lens is adapted to attach to a primary lens connector.

31. The combination according to claim 30 wherein said magnetic member is adapted to attach to a portion of the primary lens connector that does not have a screw.

32. The combination according to claim 30 wherein the primary lens connector is a magnetic member.

33. The combination according to claim 30 wherein the primary lens connector comprises a magnet attracting material.

34. The combination according to claim 1 wherein said auxiliary lens has a first side and a second side, one of said sides being adapted to be adjacent to said frameless eyeglasses when attached to said frameless eyeglasses, at least one of said auxiliary lens having an auxiliary lens connector said auxiliary lens connector being comprised of a magnetic member that magnetically adheres to a primary lens connector on said frameless eyeglasses said primary lens connector being comprised of a magnetic member and wherein at least one of said magnetic members is comprised of a magnet and the other is comprised of a magnet or a material that is attracted to a magnet.

35. The combination according to claim 34 wherein said magnetic member is in a cut out portion of said auxiliary lens connector.

36. The combination according to claim 34 wherein said primary lens connector comprises a magnet.

37. The combination according to claim 34 wherein said magnetic member in said auxiliary lens connector comprises a magnet.

38. The combination according to claim 34 wherein an interior side of the auxiliary lens connector is flush with an exterior side of the auxiliary lens.

39. The combination according to claim 34 wherein an interior side of an auxiliary lens can be in the same plane as an interior surface of the auxiliary lens connector.

40. The combination according to claim 1 wherein said auxiliary lens has a first side and a second side, one of said sides being adapted to be adjacent to said frameless eyeglasses when attached to said frameless eyeglasses, at least one of said auxiliary lens having an orifice for receiving a first sleeve and a second sleeve, said first sleeve being adapted to be received by said second sleeve, said first sleeve having a magnetic member inserted in said first sleeve when the first and second sleeves are separated sleeves, but after said first sleeve is positioned in said second sleeve the magnetic member can not be removed from said first sleeve.

41. The combination according to claim 40 wherein each sleeve has a flange which extends outward from each of said sleeve said flanges being able to keep the sleeves mechanically secured to the auxiliary lens without the use of adhesives.

42. An auxiliary lens assembly for magnetically attaching to a pair of eyeglasses, said auxiliary lens assembly comprising a first auxiliary lens attached to a second auxiliary lens by a bridge member, said auxiliary lenses having a first side and a second side, one of said sides being adapted to be adjacent to a lens on said eyeglasses when attached to said eyeglasses, at least one of said auxiliary lens having an orifice for receiving a first sleeve and a second sleeve, said first sleeve being adapted to be received by said second sleeve, said first sleeve having a magnetic member inserted in said first sleeve when the first and second sleeves are separated sleeves, but after said first sleeve is positioned in said second sleeve the magnetic member can not be removed from said first sleeve.

43. The combination according to claim 42 wherein each sleeve has a flange which extends outward from each of said sleeve said flanges being able to keep the sleeves mechanically secured to the auxiliary lens without the use of adhesives.
